(19) United States
(12) Patent Application Publication
(10) Pub. No.: US 2013/0297456 A1
(43) Pub. Date: Nov. 7, 2013

(54) Methods and Systems of Digital Rights Management for Vehicles

(71) Applicants: Brandon C. Annan, Westwood Hills, KS (US); Robert H. Burcham, Overland Park, KS (US); William F. Foust, Stilwell, KS (US); Ricky A. Hohler, Overland Park, KS (US); Robin Dale Katzer, Olathe, KS (US); Daniel L. Naden, Gardner, KS (US); Ashish K. Singh, Herndon, VA (US)

(72) Inventors: Brandon C. Annan, Westwood Hills, KS (US); Robert H. Burcham, Overland Park, KS (US); William F. Foust, Stilwell, KS (US); Ricky A. Hohler, Overland Park, KS (US); Robin Dale Katzer, Olathe, KS (US); Daniel L. Naden, Gardner, KS (US); Ashish K. Singh, Herndon, VA (US)

(73) Assignee: SPRINT COMMUNICATIONS COMPANY L.P., Overland Park, KS (US)

(21) Appl. No.: 13/463,799

(22) Filed: May 3, 2012

(51) Int. Cl. G06F 21/00; G06Q 30/06

(52) U.S. Cl. 705/26.81; 726/26

(57) ABSTRACT

A vehicle computer system including a processor and memory coupled to the processor is provided. The memory stores a plurality of vehicle applications and a vehicle application management program. The vehicle application management program, when executed by the processor, is configured to initiate restricted operations of the plurality of vehicle applications in accordance with a single digital rights payload received separately from the plurality of vehicle applications. The restricted operations of the plurality of vehicle applications comprise a multimedia operation and a remote access operation.

### CROSS-REFERENCE TO RELATED APPLICATIONS

None.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Digital rights management (DRM) refers to access control technologies that are used to limit access to digital content before or after their purchase. Examples of digital content include, but are not limited to, applications, application features, and digital media such as movies, music, and games. DRM techniques and restrictions often vary for different types of digital content and different types of devices that execute digital content.

Applying DRM to vehicles raises various issues. For example, it is common for the ownership of a vehicle to change various times over the lifetime of the vehicle. Further, a vehicle manufacturer may want to offer different applications or features for different vehicles. The issues of how, when, and what to install on a vehicle in relation to digital content and related digital rights is not a trivial question.

### SUMMARY

In some embodiments, a vehicle computer system comprising a processor and memory coupled to the processor is provided. The memory stores a plurality of vehicle applications and a vehicle application management program. The vehicle application management program, when executed by the processor, is configured to initiate restricted operations of the plurality of vehicle applications in accordance with a single digital rights payload received separately from the plurality of vehicle applications. The restricted operations of the plurality of vehicle applications comprise a multimedia operation and a remote access operation.

Some embodiments provide a method comprising processing, by a merchant transaction server, a request to purchase a restricted vehicle application or a restricted vehicle application feature. The merchant transaction server submits a digital rights management (DRM) sync request to a management database. The management database forwards a DRM package corresponding to the DRM sync request to a vehicle remote operations server. A vehicle head unit performs a DRM sync based on a DRM sync message received from the vehicle remote operations server to enable use of the restricted vehicle application or the restricted vehicle application feature.

In some embodiments, a system comprises a computing device that prepares a digital rights management (DRM) payload based on a vehicle identification number (VIN) and a subscriber identifier (ID). A vehicle head unit receives the DRM payload from the computing device and authorizes use of a restricted vehicle application or a restricted vehicle application feature received separately from the DRM payload in response to unwrapping the DRM payload using the VIN and the subscriber identifier.

These and other features will be more clearly understood from the following detailed description taken in conjunction with the accompanying drawings and claims.

### BRIEF DESCRIPTION OF THE DRAWINGS

For a more complete understanding of the present disclosure, reference is now made to the following brief description, taken in connection with the accompanying drawings and detailed description, wherein like reference numerals represent like parts.

FIG. 1 illustrates a system suitable for implementing the several embodiments of the disclosure;

FIG. 2 illustrates a system with steps noted for implementing the several embodiments of the disclosure;

FIG. 3 illustrates a method chart for implementing the several embodiments of the disclosure;

FIG. 4 shows a block diagram of a mobile device for implementing the several embodiments of the disclosure;

FIG. 5A illustrates a software environment that may be implemented by the DSP of FIG. 4 for implementing the several embodiments of the disclosure;

FIG. 5B illustrates an alternative software environment that may be implemented by the DSP of FIG. 4 for implementing the several embodiments of the disclosure;

FIG. 6 illustrates an exemplary computer system suitable for implementing the several embodiments of the disclosure; and

FIG. 7 illustrates a method for implementing an embodiment of the disclosure.

### DETAILED DESCRIPTION

It should be understood at the outset that although illustrative implementations of one or more embodiments are illustrated below, the disclosed systems and methods may be implemented using any number of techniques, whether currently known or not yet in existence. The disclosure should in no way be limited to the illustrative implementations, drawings, and techniques illustrated below, but may be modified within the scope of the appended claims along with their full scope of equivalents.

Embodiments of the disclosure are directed to methods and systems for managing distribution and use of restricted applications or restricted application features on a vehicle. For example, in an embodiment, restricted applications or restricted application features may comprise multimedia operations and/or remote access operation. For example, accessing multimedia content may be enabled under some scenarios. The ability to perform remote operations via a vehicle head unit such as unlock vehicle doors may be enabled under some scenarios. The ability to exercise individualized functionality, for example providing recommendations based on a personal profile or to pay for good using confidential financial information such as credit card number and authorization codes may be enabled under some scenarios.

In at least some embodiments, the restricted applications or restricted application features are provided to the vehicle separately from the digital rights that enable use of the restricted applications or restricted application features. For some vehicles, all of the restricted applications or restricted application features that may be activated are provided prior to receipt of the corresponding digital rights. Further, different vehicles may have a different set of restricted applications or restricted application features that may be activated with receipt of the corresponding digital rights by the vehicle. The digital rights provided to a vehicle may be provided as a single (holistic) digital rights payload corresponding to one of several packages compatible with the restricted applications or restricted application features of a vehicle. The digital rights packages may be organized in a table, and sales criteria/codes may be employed to determine which package is offered for a vehicle and which packages are available as upgrades for a vehicle.

As an example, after restricted applications or restricted application features are stored by a vehicle head unit, the vehicle head unit may receive a demo digital rights payload to enable demonstration of the restricted applications or restricted application features while a vehicle is at the dealer's lot. The demo digital rights payload may be the same or may be different than the digital rights package that is offered with the vehicle. In this manner, a purchaser is able to test various restricted applications or restricted application features prior to purchase. If the demo digital rights package is anonymous, features that are specific to a user (i.e., features that rely on a user identifier) will not be activated. After a vehicle is purchased, the demo digital rights package expires within a predetermined time (e.g., 3 days). Before the demo digital rights package expires, a vehicle purchaser is able to register the vehicle head unit via a registration service that is available online, through a call center, or through the vehicle's head unit. The registration of the vehicle head unit associates the vehicle head unit with a particular subscriber or subscriber account and causes a digital rights payload corresponding to the purchased digital rights package to be received by the vehicle head unit to replace the demo digital rights package, which may or may not be expired. In similar manner, an upgraded digital rights package may later be purchased and will replace the current digital rights package of a vehicle head unit. In similar manner, a digital rights package may later be purchased to replace a trial digital rights package that is specific to a user and that will expire after a predetermined amount of time. For leased vehicles, anonymous or user-specific digital rights packages that are temporary may be provided. For example information regarding registration of a vehicle head unit, reference may be had to U.S. patent application Ser. No. 13/455,121 filed Apr. 24, 2012, and entitled “In-car Head Unit Wireless Communication Service Subscription Initiation,” by Burcham, et al., which is hereby incorporated by reference in its entirety.

To support the appropriate distribution of digital rights payloads to vehicles as described herein, synchronization of digital rights information across various system components such as a merchant transaction server, a management database, and a vehicle head unit is performed. Further, to support the appropriate distribution of digital rights payloads to vehicles as described herein, each digital rights payload may be tied to a particular vehicle identification number (VIN) and/or to a subscriber identifier.

A system to manage distribution and use of restricted applications or restricted application features on a vehicle may include a merchant transaction server in communication with a management database and a telematics unit. The merchant transaction server may maintain an online store front from which restricted applications, restricted application features, or digital rights packages (distributed separately from the restricted application or restricted application features) may be purchased. The management database stores subscription information related to purchases, and may provision or provide the subscription information to various service delivery platforms to enable appropriate distribution of digital rights management payloads to the telematics unit. To support distribution of digital rights management payloads to the telematics unit, the system may also comprise various other components including a dispatcher unit, a service handler unit, a service integrator unit, and a customer data provider unit. In one embodiment, the merchant transaction server, the management database, and a related store front may be operated and maintained to manage digital rights purchases and/or subscriptions. Meanwhile, the customer data provider unit, the service handler unit, and the service integrator unit may be operated and maintained to assist with distribution of digital rights management payloads corresponding to purchases or subscriptions to a telematics unit. The dispatcher unit also may be operated and maintained to assist with distribution of the digital rights management payloads to a telematics unit. The telematics unit is provided with a vehicle (e.g., as part of a vehicle head unit) and comprises hardware operations or software executed by a processor to manage use of restricted applications or restricted application features based on digital rights management payloads received from the distribution components of the system, where the distribution is based on the store front and/or subscription management components of the system.

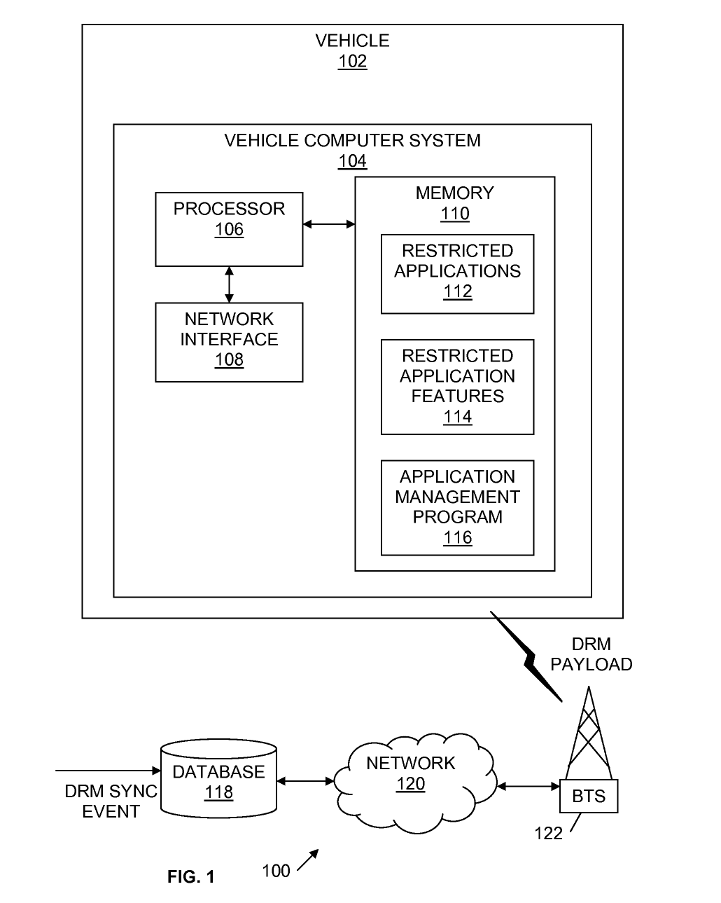

FIG. 1 illustrates a system 100 suitable for implementing the several embodiments of the disclosure. As shown in FIG. 1, the system 100 comprises a vehicle 102 in communication with a database 118. In one embodiment, data (e.g., a DRM payload) may be transmitted from the database 118 to the vehicle 102 via a network 120 and a base transceiver station (BTS) 122 that employs a cellular radio link to communicate with the vehicle 102. Similarly, the vehicle 102 may transmit data to the database 118 via the base transceiver station (BTS) 122 and the network 120.

As shown, the vehicle 102 comprises a vehicle computer system 104 having a processor 106 coupled to a memory 110 and a network interface 108. The memory 110 stores restricted applications 112 and/or restricted application features 114. The memory 110 also stores an application management program 116 that manages digital rights for the restricted applications 112 and/or restricted application features 114. In some contexts, the vehicle computer system 108 may be referred to as a head unit.

In system 100, the database 118 provides a digital rights management (DRM) payload to the vehicle computer system 104 in response to a DRM sync event. For example, the DRM sync event may be based on a digital rights purchase carried out online or via a vehicle head unit. For example, an online vehicle application storefront may be maintained to enable purchases of digital rights packages for a particular vehicle. The online vehicle application storefront may be accessed via a computer with Internet access. Additionally or alternatively, a call center may be maintained to enable purchase of digital rights packages. In some embodiments, a vehicle head unit may enable online access or placing a phone call to purchase digital rights packages. Each digital rights purchase may be specific to a particular vehicle as identified by a VIN, a subscriber identifier, or other identifier.

Additionally or alternatively, the DRM sync event may be based on an administrator request. For example, a DRM sync request may be issued by an administrator as a vehicle-specific request to update user accessibility to at least one restricted application or restricted application feature. Alternatively, a DRM sync request may be issued by an administrator as a vehicle-generic request (issued to multiple vehicles according to some selection criteria such as brand, model, year) to update user accessibility to at least one restricted application or restricted operation feature. The DRM sync request may be issued by an administrator to update the digital rights package of a vehicle, or to add/update a digital rights package to a vehicle in response to a life cycle event. Such life cycle events may include, for example, when a vehicle arrives to a distributor, when a vehicle arrives to a dealer (a vehicle-to-dealer event), or when a vehicle is purchased (a vehicle-to-user event). Further, the application management program 116 may disable restricted applications and/or restricted application features (also referred to herein as restricted operations of vehicle applications) upon request from an administrator. For example, if registration has not occurred within a predetermined time period of a vehicle-to-user event, an existing digital rights package may expire such that the restricted applications and/or restricted application features are no longer available. Alternatively, a more limited digital rights payload may be transmitted to the vehicle to replace a digital rights package due to its expiration.

The handling of DRM payloads received from the database 118 is provided by the vehicle computer system 104 by execution of the application management program 116. When executed by the processor 106, the application management program 116 is configured to initiate operations of the restricted applications and/or restricted application features in accordance with a digital rights payload received separately from the restricted applications and/or restricted application features. In other words, the application management program 116 enables restricted operations of one or more vehicle applications in accordance with a single, holistic digital rights payload received separately from the plurality of vehicle applications. The single digital rights payload enables use of all restricted applications and/or restricted application features of a digital rights package, where different digital rights packages correspond to different tiers (e.g., platinum, gold, and silver) of services/capabilities. As an example, the restricted operations of the plurality of vehicle applications may comprise multimedia operations (e.g., movies or music), and remote access operations (e.g., locking/unlocking a door, starting the engine, opening a garage, global positioning system (GPS) operations, emergency operations, or other telematic operations). In an embodiment, upon initiation, each restricted application and/or restricted application feature reads its own DRM from local storage, where the DRM may define a time limit or a tier for access to content. If the time limit associated with an application or application feature has expired, the restricted application or feature does not load or otherwise function properly. Likewise, if the tier defined by the DRM provides limited access to content/services, restricted content/services that are not allowed by the DRM read from local storage will not load or otherwise function properly.

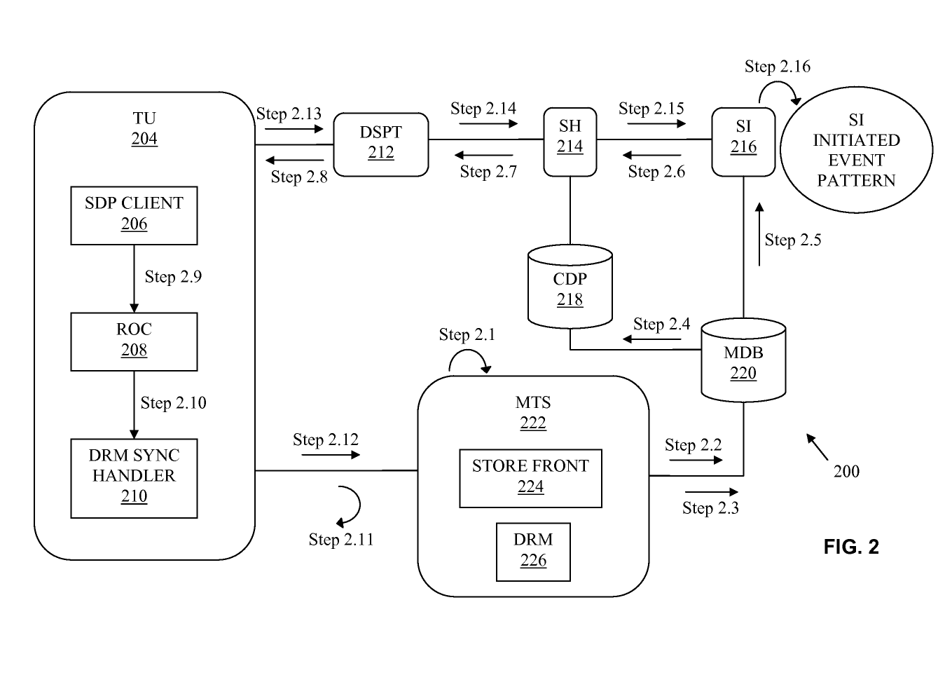

FIG. 2 illustrates a system 200 with steps noted for implementing the several embodiments of the disclosure. As shown, the system 200 comprises a merchant transaction server (MTS) 222 in communication with a management database (MDB) 220 and a telematics unit (TU) 204. In some embodiments, the telematics unit 204 corresponds to the vehicle computer system 104 and the management database 220 corresponds to the database 118 of FIG. 1. In an embodiment, the management database 220 stores subscription information and may provision or provide that information into various service delivery platforms. To enable appropriate distribution of DRM payloads to the telematics unit 204, the system 200 may also comprise various other components including a dispatcher (DSPT) unit 212, a service handler (SH) unit 214, a service integrator (SI) unit 216, and a customer data provider (CDP) unit 218. The different components of system 200 may correspond to separate computing units or servers that communicate using one or more pre-established communication protocols. The various components of system 200 may be operated and maintained by different companies to provide distribution of DRM payloads to telematics unit 204. For example, in one embodiment, the merchant transaction server 222 and management database 220 may be operated and maintained by a first company. Meanwhile, the customer data provider unit 218, the service handler unit 214, and the service integrator unit 216 may be operated and maintained by a second company. Meanwhile, the dispatcher unit 212 may be operated and maintained by a third company.

The steps performed by the system 200 are labeled as steps 2.1-2.16. Although the steps 2.1-2.16 may be performed sequentially, it should be noted that some of the steps may be performed in parallel. At step 2.1, the merchant transaction server 222 is notified of a DRM sync event and DRM rights corresponding to the DRM sync event are calculated by DRM component 226 of the merchant transaction server 222. In at least some embodiments, the MTS 222 provides a vehicle DRM package based on the calculated rights. The DRM package may comprise, for example, three JavaScript Object Notation (JSON) formatted files including: 1) a native.dat file that defines DRM for native in-vehicle applications; 2) an ams.dat file that defines DRM for Java in-vehicle applications; and 3) a ngtp.dat file that defines DRM for next generation telematics protocol (NGTP) operations delivered via a service delivery platform (SDP) session. As an example, the DRM for native in-vehicle applications may control access to applications or features such as a Wi-Fi hot spot application and a short message service (SMS) reader. Meanwhile, the DRM for Java in-vehicle applications may control access to applications or features such as infotainment, Facebook®, and Pandora®. Meanwhile, the DRM for next generation telematics protocol operations may control access to applications or features such as remote lock/unlock, remote engine start/stop, and emergency services. The DRM sync event of step 2.1 may be based on a purchase or an administrator request as previously discussed. As shown, the merchant transaction server 222 may maintain the online store front 224 from which restricted application, restricted application features, or digital rights packages (distributed separately from the restricted application or restricted application features) may be purchased.

At step 2.2, the merchant transaction server 222 notifies management database 220 regarding a DRM update and, at step 2.3, the management database 220 retrieves a corresponding DRM file from the merchant transaction server 222. At step 2.4, the management database 220 provisions DRM operations to the customer data provider unit 218. At step 2.5, the SI unit 216 requests DRM sync information from the management database 220 and sends a corresponding DRM sync event to the service handler unit 214 at step 2.6. The service handler unit 214 then forwards the same or similar DRM sync event to the dispatcher unit 212 at step 2.7 after which the dispatcher unit 212 notifies the telematics units 204 of the DRM sync event at step 2.8. In response, a service delivery platform client 206 of the telematics units 204 triggers a remote operations client (ROC) 208 for a DRM sync event at step 2.9. The remote operations client 208 then notifies a DRM sync handler 210 and triggers a DRM sync at step 2.10. At step 2.11, the telematics units 204 retrieves DRM and application binaries (e.g., the native.dat, the ams.dat, and the ngtp.dat files) from the merchant transaction server 222 and subsequently notifies the merchant transaction server 222 when the DRM sync has been completed at step 2.12.

The telematics units 204 also may send a DRM sync completion notification to the dispatcher unit 212 at step 2.13, which forwards the same (or similar) DRM sync completion notification to the service handler unit 214 at step 2.14. The service handler unit 214 likewise forwards the same (or similar) DRM sync completion notification to the service integrator unit 216 at step 2.15. Finally, the service integrator unit 216 provides an service integrator unit initiated event pattern at step 2.16.

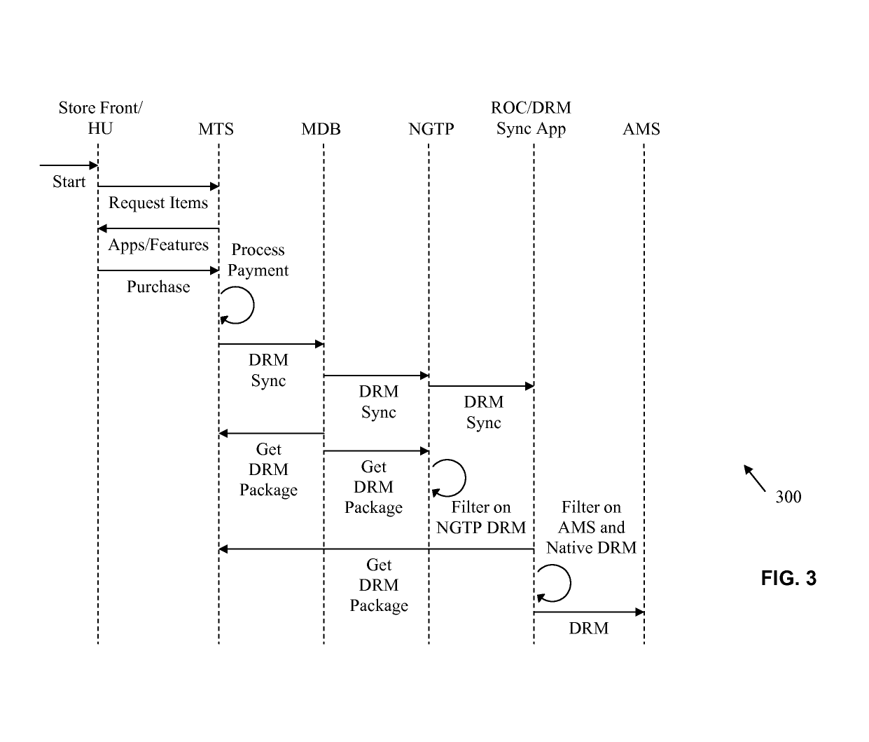

FIG. 3 illustrates a method chart 300 for implementing the several embodiments of the disclosure. The method chart 300 starts at an online store front or a vehicle head unit (HU) when items are requested from a merchant transaction server. The head unit of FIG. 3 may correspond to the vehicle computer system 104 of FIG. 1 or the telematics unit 204 of FIG. 2. Meanwhile, the merchant transaction server and the online store front of FIG. 3 may correspond respectively to the merchant transaction server 222 and the store front 224 of FIG. 2. The items requested may, for example, correspond to restricted applications and/or restricted application features that are compatible with the vehicle head unit, but that are not yet stored on the vehicle head unit. Alternatively, the items requested may correspond to a digital rights package that is needed to operate restricted applications and/or restricted application features that are already stored by the vehicle head unit.

The merchant transaction server enables a vehicle owner to review the restricted applications, the restricted application features, or the digital rights packages that are available for purchase. Once a purchase is made, the merchant transaction server processes the payment and a DRM sync corresponding to the purchase is initiated when the merchant transaction server notifies the management database, which may correspond to the management database 220 of FIG. 2. The management database transmits the same or similar DRM sync request and a “get DRM package” request to a next generation telematics protocol component, which may correspond to the dispatcher unit 212 of FIG. 2. The management database also sends the “get DRM package” request to the merchant transaction server. In response to the DRM sync request received from the management database, the next generation telematics protocol component transmits the same or similar DRM sync request to a remote operations client/DRM sync application at the vehicle head unit. The remote operations client/DRM sync application of FIG. 3 may correspond to the remote operations client 208 and the DRM sync handler 210 of FIG. 2. In some embodiments, the DRM sync request from the next generation telematics protocol to the remote operations client/DRM sync application is in the form of a short message service (SMS) push message. The next generation telematics protocol component also filters the next generation telematics protocol DRM information (e.g., the ngtp.dat file) according to predetermined criteria.

As shown in method chart 300, the remote operations client/DRM sync application sends a “get DRM package” request to the merchant transaction server. The remote operations client/DRM sync application also filters the application management software (AMS) DRM information (e.g., the ams.dat file) and the native DRM information (e.g, the native.dat file) according to predetermined criteria. With the filtered next generation telematics protocol DRM information, the filtered application management software DRM information, and the filtered native DRM information, the remote operatons client/DRM sync application provides a DRM sync request to the application management software to complete the DRM sync. The application management software of FIG. 3 may correspond to, for example, the application management program 112 of FIG. 1 or the DRM sync handler 210 of FIG. 2.

In at least some embodiments, the systems 100 and 200, and the method chart 300 correspond to a system in which a computing device prepares a DRM payload based on a VIN and a subscriber identifier. For example, the DRM payload may be part of a blob that is signed/encrypted using the VIN and/or the subscriber identifier. A vehicle head unit receives the DRM payload from the computing device and authorizes use of a restricted vehicle application or a restricted vehicle application feature received separately from the DRM payload in response to decrypting/unwrapping the DRM payload using the correct VIN and/or subscriber identifier. In some embodiments, the computing device prepares the DRM payload in response to a purchase request received from an online store front or from the vehicle head unit. The computing device also may prepare different DRM payloads in response to an administrator request or in response to different vehicle life cycle events. Further, the computer device may initiate a monetary settlement between two entities (e.g., a car manufacturer and a content service provider) in response to at least one of the different vehicle life cycle events. In at least some embodiments, the vehicle head unit stores a collection of restricted vehicle applications or restricted vehicle application features, and is configured to authorize use of different sub-sets of the collection of restricted vehicle applications or restricted vehicle application features in accordance with different DRM payloads.

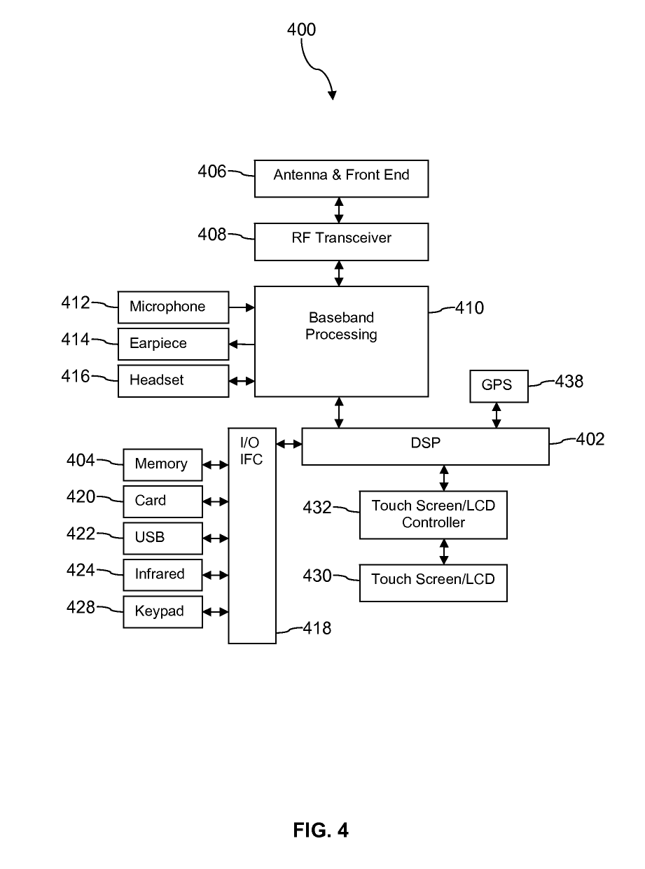

FIG. 4 shows a block diagram of a mobile device 400 for implementing the several embodiments of the disclosure. The mobile device 400 may be an example of the vehicle computer system 104 depicted in FIG. 1, the telematics unit 204 depicted in FIG. 2, or the head unit of FIG. 3. While a variety of known components of mobile devices are depicted in FIG. 4, in an embodiment a subset of the listed components and/or additional components not listed may be included in the mobile device 400. The mobile device 400 includes a digital signal processor (DSP) 402 and a memory 404. As shown, the mobile device 400 may further include an antenna and front end unit 406, a radio frequency (RF) transceiver 408, a baseband processing unit 410, a microphone 412, an earpiece speaker 414, a headset port 416, an input/output interface 418, a removable memory card 420, a universal serial bus (USB) port 422, an infrared port 424, a keypad 428, a touch screen liquid crystal display (LCD) with a touch sensitive surface 430, a touch screen/LCD controller 432, and a global positioning system (GPS) receiver 438. In an embodiment, the mobile device 400 may include another kind of display that does not provide a touch sensitive screen. In an embodiment, the DSP 402 may communicate directly with the memory 404 without passing through the input/output interface 418. Additionally, in an embodiment, the mobile device 400 may comprise other peripheral devices that provide other functionality.

The DSP 402 or some other form of controller or central processing unit operates to control the various components of the mobile device 400 in accordance with embedded software or firmware stored in memory 404 or stored in memory contained within the DSP 402 itself. In addition to the embedded software or firmware, the DSP 402 may execute other applications stored in the memory 404 or made available via information carrier media such as portable data storage media like the removable memory card 420 or via wired or wireless network communications. The application software may comprise a compiled set of machine-readable instructions that configure the DSP 402 to provide the desired functionality, or the application software may be high-level software instructions to be processed by an interpreter or compiler to indirectly configure the DSP 402. As an example, the memory 404 may store, for executed by the DSP 402, the restricted applications 112, the restricted application features 114, and the application management program 116 depicted for FIG. 1. Additionally or alternatively, the memory 404 may store, for execution by the DSP 402, the service delivery platform client 206, the remote operations client 208, and the DRM sync handler 210 depicted for FIG. 2.

The DSP 402 may communicate with a wireless network via the analog baseband processing unit 410. In some embodiments, the communication may provide Internet connectivity, enabling a user to gain access to content on the Internet and to send and receive e-mail or text messages. The input/output interface 418 interconnects the DSP 402 and various memories and interfaces. The memory 404 and the removable memory card 420 may provide software and data to configure the operation of the DSP 402. Among the interfaces may be the USB port 422 and the infrared port 424. The USB port 422 may enable the mobile device 400 to function as a peripheral device to exchange information with a personal computer or other computer system. The infrared port 424 and other optional ports such as a Bluetooth® interface or an IEEE 802.11 compliant wireless interface may enable the mobile device 400 to communicate wirelessly with other nearby handsets and/or wireless base stations.

The keypad 428 couples to the DSP 402 via the interface 418 to provide one mechanism for the user to make selections, enter information, and otherwise provide input to the mobile device 400. Another input mechanism may be the touch screen LCD 430, which may also display text and/or graphics to the user. The touch screen LCD controller 432 couples the DSP 402 to the touch screen LCD 430. The GPS receiver 438 is coupled to the DSP 402 to decode global positioning system signals, thereby enabling the mobile device 400 to determine its position.

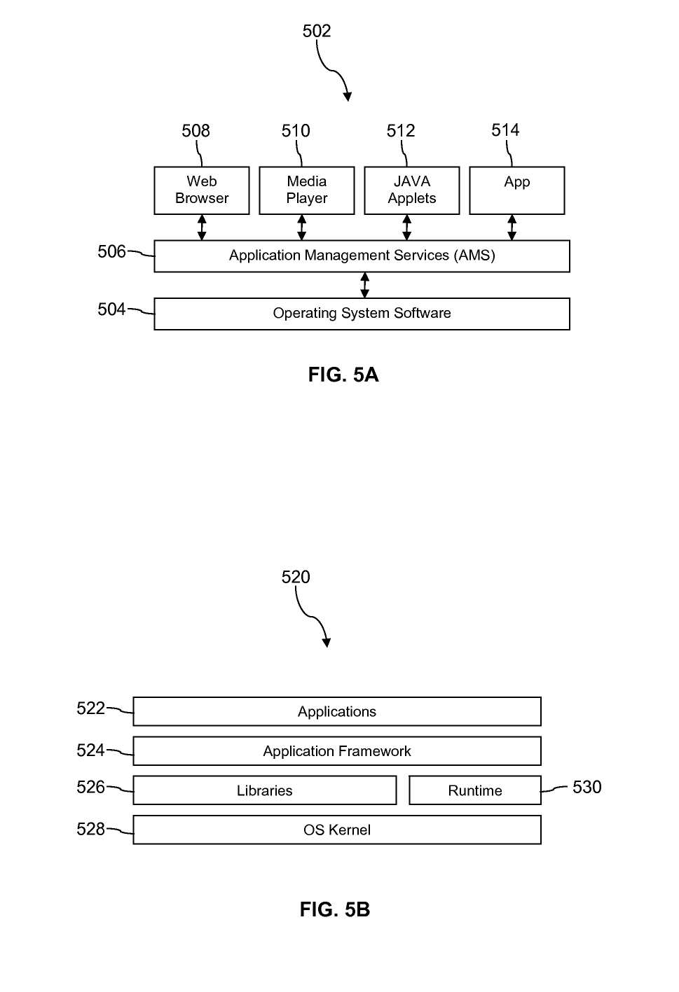

FIG. 5A illustrates a software environment 502 that may be implemented by the DSP 402 of FIG. 4. The DSP 402 executes operating system software 504 that provides a platform from which the rest of the software operates. The operating system software 504 may provide a variety of drivers for the head unit hardware with standardized interfaces that are accessible to application software. The operating system software 504 may be coupled to and interact with application management services (AMS) 506 that transfers control between applications running on the mobile device 400. Also shown in FIG. 5A are a web browser application 508, a media player application 510, JAVA applets 512, and application 514. The web browser application 508 may be executed by the mobile device 400 to browse content and/or the Internet, for example when the mobile device 400 is coupled to a network via a wireless link. The web browser application 508 may permit a user to enter information into forms and select links to retrieve and view web pages. The media player application 510 may be executed by the mobile device 400 to play audio or audiovisual media. The JAVA applets 512 may be executed by the mobile device 400 to provide a variety of functionality including games, utilities, and other functionality. The application 514 may perform various DRM sync operations as described herein.

FIG. 5B illustrates an alternative software environment 520 that may be implemented by the DSP 402 of FIG. 4. The DSP 402 executes operating system software 528 and an execution runtime 530. The DSP 402 executes applications 522 that may execute in the execution runtime 530 and may rely upon services provided by the application framework 524. Applications 522 and the application framework 524 may rely upon functionality provided via the libraries 526.

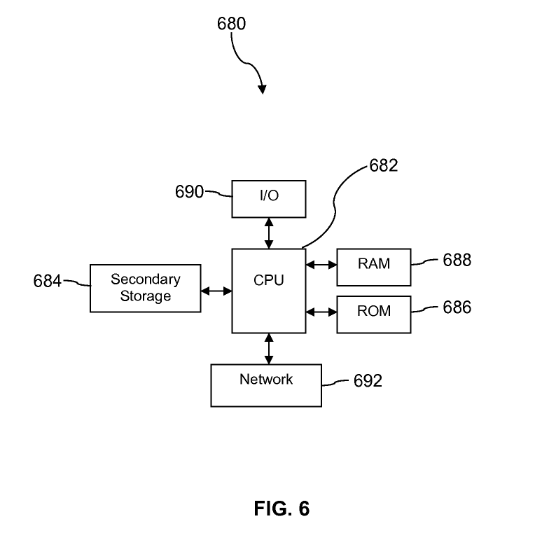

FIG. 6 illustrates an exemplary computer system 680 suitable for implementing one or more embodiments of the disclosure herein. The computer system 680 may correspond to components of the vehicle computer system 104, or components of a server or other processing component described herein (e.g., the merchant transaction server 222, the dispatcher unit 212, the service handler unit 214, the service integrator unit 216, the telematics unit 204, or the head unit). The computer system 680 includes a processor 682 (which may be referred to as a central processor unit or CPU) that is in communication with memory devices including secondary storage 684, read only memory (ROM) 686, random access memory (RAM) 688, input/output (I/O) devices 690, and network connectivity devices 692. The processor 682 may be implemented as one or more CPU chips.

It is understood that by programming and/or loading executable instructions onto the computer system 680, at least one of the CPU 682, the RAM 688, and the ROM 686 are changed, transforming the computer system 680 in part into a particular machine or apparatus having the novel functionality taught by the present disclosure. It is fundamental to the electrical engineering and software engineering arts that functionality that can be implemented by loading executable software into a computer can be converted to a hardware implementation by well known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware, for example in an application specific integrated circuit (ASIC), because for large production runs the hardware implementation may be less expensive than the software implementation. Often a design may be developed and tested in a software form and later transformed, by well known design rules, to an equivalent hardware implementation in an application specific integrated circuit that hardwires the instructions of the software. In the same manner as a machine controlled by a new ASIC is a particular machine or apparatus, likewise a computer that has been programmed and/or loaded with executable instructions may be viewed as a particular machine or apparatus.

The secondary storage 684 is typically comprised of one or more disk drives or tape drives and is used for non-volatile storage of data and as an over-flow data storage device if RAM 688 is not large enough to hold all working data. Secondary storage 684 may be used to store programs which are loaded into RAM 688 when such programs are selected for execution. The ROM 686 is used to store instructions and perhaps data which are read during program execution. ROM 686 is a non-volatile memory device which typically has a small memory capacity relative to the larger memory capacity of secondary storage 684. The RAM 688 is used to store volatile data and perhaps to store instructions. Access to both ROM 686 and RAM 688 is typically faster than to secondary storage 684. The secondary storage 684, the RAM 688, and/or the ROM 686 may be referred to in some contexts as computer readable storage media and/or non-transitory computer readable media.

I/O devices 690 may include printers, video monitors, liquid crystal displays (LCDs), touch screen displays, keyboards, keypads, switches, dials, mice, track balls, voice recognizers, card readers, paper tape readers, or other well-known input devices.

The network connectivity devices 692 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards such as code division multiple access (CDMA), global system for mobile communications (GSM), long-term evolution (LTE), worldwide interoperability for microwave access (WiMAX), and/or other air interface protocol radio transceiver cards, and other well-known network devices. These network connectivity devices 692 may enable the processor 682 to communicate with the Internet or one or more intranets. With such a network connection, it is contemplated that the processor 682 might receive information from the network, or might output information to the network in the course of performing the above-described method steps. Such information, which is often represented as a sequence of instructions to be executed using processor 682, may be received from and outputted to the network, for example, in the form of a computer data signal embodied in a carrier wave.

Such information, which may include data or instructions to be executed using processor 682 for example, may be received from and outputted to the network, for example, in the form of a computer data baseband signal or signal embodied in a carrier wave. The baseband signal or signal embedded in the carrier wave, or other types of signals currently used or hereafter developed, may be generated according to several methods well known to one skilled in the art. The baseband signal and/or signal embedded in the carrier wave may be referred to in some contexts as a transitory signal.

The processor 682 executes instructions, codes, computer programs, scripts which it accesses from hard disk, floppy disk, optical disk (these various disk based systems may all be considered secondary storage 684), ROM 686, RAM 688, or the network connectivity devices 692. While only one processor 682 is shown, multiple processors may be present. Thus, while instructions may be discussed as executed by a processor, the instructions may be executed simultaneously, serially, or otherwise executed by one or multiple processors. Instructions, codes, computer programs, scripts, and/or data that may be accessed from the secondary storage 684, for example, hard drives, floppy disks, optical disks, and/or other device, the ROM 686, and/or the RAM 688 may be referred to in some contexts as non-transitory instructions and/or non-transitory information.

In an embodiment, the computer system 680 may comprise two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the computer system 680 to provide the functionality of a number of servers that is not directly bound to the number of computers in the computer system 680. For example, virtualization software may provide twenty virtual servers on four physical computers. In an embodiment, the functionality disclosed above may be provided by executing the application and/or applications in a cloud computing environment. Cloud computing may comprise providing computing services via a network connection using dynamically scalable computing resources. Cloud computing may be supported, at least in part, by virtualization software. A cloud computing environment may be established by an enterprise and/or may be hired on an as-needed basis from a third party provider. Some cloud computing environments may comprise cloud computing resources owned and operated by the enterprise as well as cloud computing resources hired and/or leased from a third party provider.

In an embodiment, some or all of the functionality disclosed above may be provided as a computer program product. The computer program product may comprise one or more computer readable storage medium having computer usable program code embodied therein to implement the functionality disclosed above. The computer program product may comprise data structures, executable instructions, and other computer usable program code. The computer program product may be embodied in removable computer storage media and/or non-removable computer storage media. The removable computer readable storage medium may comprise, without limitation, a paper tape, a magnetic tape, magnetic disk, an optical disk, a solid state memory chip, for example analog magnetic tape, compact disk read only memory (CD-ROM) disks, floppy disks, jump drives, digital cards, multimedia cards, and others. The computer program product may be suitable for loading, by the computer system 680, at least portions of the contents of the computer program product to the secondary storage 684, to the ROM 686, to the RAM 688, and/or to other non-volatile memory and volatile memory of the computer system 680. The processor 682 may process the executable instructions and/or data structures in part by directly accessing the computer program product, for example by reading from a CD-ROM disk inserted into a disk drive peripheral of the computer system 680. Alternatively, the processor 682 may process the executable instructions and/or data structures by remotely accessing the computer program product, for example by downloading the executable instructions and/or data structures from a remote server through the network connectivity devices 692. The computer program product may comprise instructions that promote the loading and/or copying of data, data structures, files, and/or executable instructions to the secondary storage 684, to the ROM 686, to the RAM 688, and/or to other non-volatile memory and volatile memory of the computer system 680.

In some contexts, the secondary storage 684, the ROM 686, and the RAM 688 may be referred to as a non-transitory computer readable medium or a computer readable storage media. A dynamic RAM embodiment of the RAM 688, likewise, may be referred to as a non-transitory computer readable medium in that while the dynamic RAM receives electrical power and is operated in accordance with its design, for example during a period of time during which the computer 680 is turned on and operational, the dynamic RAM stores information that is written to it. Similarly, the processor 682 may comprise an internal RAM, an internal ROM, a cache memory, and/or other internal non-transitory storage blocks, sections, or components that may be referred to in some contexts as non-transitory computer readable media or computer readable storage media.

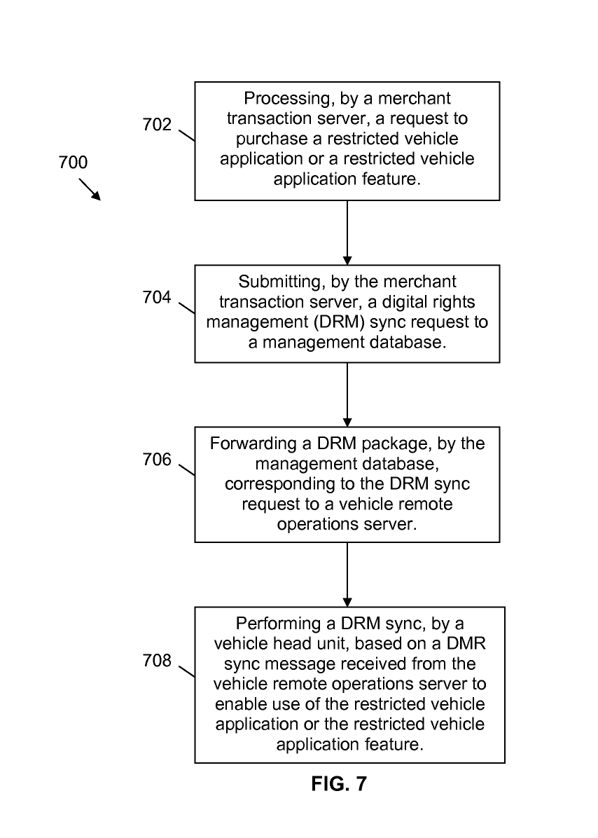

FIG. 7 illustrates a method 700 for implementing an embodiment of the disclosure. As shown, the method 700 comprises processing, by a merchant transaction server, a request to purchase a restricted vehicle application or a restricted vehicle application feature (block 702). The merchant transaction server submits a DRM sync request to a management database at block 704. The management database forwards a DRM package corresponding to the DRM sync request to a vehicle remote operations server at block 706. For example, the vehicle remote operations server may correspond to a next generation telematics protocol server. Finally, the vehicle head unit performs a DRM sync based on a DRM sync message received from the vehicle remote operations server to enable use of the purchased restricted vehicle application or the restricted vehicle application feature. The vehicle remote operations server may, for example, provide the DMR sync message to the vehicle head unit as a short message service push message. In at least some embodiments of method 700, the merchant transaction server and management database are operated and maintained by a first company, while the vehicle remote operations server is operated and maintained by a second company.

The method 700 may comprise additional alternative steps. For example, the merchant transaction server may receive the request to purchase the restricted vehicle application or the restricted vehicle application feature from an online store front. Alternatively, the merchant transaction server may receive the request to purchase the restricted vehicle application or the restricted vehicle application feature from the vehicle head unit. Further, the method 700 may comprise receiving, by the merchant transaction server, the DRM package from the management database and receiving a DRM sync completion confirmation corresponding to the DRM package from the vehicle head unit. Further, the method 700 may comprise filtering, by the vehicle remote operations server, DRM information for remote operation services and filtering, by the vehicle head unit, DRM information for native in-vehicle operations and DRM information for Java in-vehicle operations.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted or not implemented.

Also, techniques, systems, subsystems, and methods described and illustrated in the various embodiments as discrete or separate may be combined or integrated with other systems, modules, techniques, or methods without departing from the scope of the present disclosure. Other items shown or discussed as directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

What is claimed is:

1. A vehicle computer system, comprising:
a processor;
a memory coupled to the processor, wherein the memory stores a plurality of vehicle applications and a vehicle application management program,
wherein the vehicle application management program, when executed by the processor, is configured to initiate restricted operations of the plurality of vehicle applications in accordance with a single digital rights payload received separately from the plurality of vehicle applications,
wherein the restricted operations of the plurality of vehicle applications comprise a multimedia operation and a remote access operation.

2. The vehicle computer system of claim 1, wherein the vehicle application management program is configured to respond to a digital rights management (DRM) sync event by retrieving a new single digital rights payload from a remote database.

3. The vehicle computer system of claim 1, wherein the vehicle application management program is configured to respond to a digital rights management (DRM) sync event by retrieving the single digital rights payload from a remote database.

4. The vehicle computer system of claim 3, wherein the DRM sync event is triggered by a user submitting a vehicle-specific purchase of a restricted operation feature via an online vehicle application storefront.

5. The vehicle computer system of claim 3, wherein the DRM sync event is triggered by a user submitting a vehicle-specific purchase of a restricted operation feature via a communication interface of the vehicle computer system.

6. The vehicle computer system of claim 3, wherein the DRM sync event is triggered by a vehicle manufacturer submitting a vehicle-specific request to update user accessibility to at least one restricted operation feature.

7. The vehicle computer system of claim 3, wherein the DRM sync event is triggered by a vehicle manufacturer submitting a request to update accessibility to at least one restricted operation feature.

8. The vehicle computer system of claim 3, wherein the DRM sync event is triggered for each of a plurality of predetermined vehicle life cycle events, wherein said plurality of predetermined vehicle life cycle events comprise a vehicle-to-dealer event and a vehicle-to-user event.

9. The vehicle computer system of claim 8, wherein the vehicle application management program disables restricted operations of the plurality of vehicle applications authorized by the single digital rights payload in response to detection that registration has not occurred within a predetermined time period of the vehicle-to-user event.

10. A method comprising:
processing, by a merchant transaction server, a request to purchase a restricted vehicle application or a restricted vehicle application feature;
submitting, by the merchant transaction server, a digital rights management (DRM) sync request to a management database;
forwarding a DRM package, by the management database, corresponding to the DRM sync request to a vehicle remote operations server;
performing a DRM sync, by a vehicle head unit, based on a DRM sync message received from the vehicle remote operations server to enable use of the restricted vehicle application or the restricted vehicle application feature.

11. The method of claim 10, further comprising receiving, by the merchant transaction server, the request to purchase the restricted vehicle application or the restricted vehicle application feature from an online store front.

12. The method of claim 10, further comprising receiving, by the merchant transaction server, the request to purchase the restricted vehicle application or the restricted vehicle application feature from the vehicle head unit.

13. The method of claim 10, further comprising receiving, by the merchant transaction server, the DRM package from the management database and receiving a DRM sync completion confirmation corresponding to the DRM package from the vehicle head unit.

14. The method of claim 10, further comprising providing, by the vehicle remote operations server, the DMR sync message to the vehicle head unit as a SMS push message.

15. The method of claim 10, further comprising filtering, by the vehicle remote operations server, DRM information for remote operation services and filtering, by the vehicle head unit, DRM information for native in-vehicle operations and DRM information for Java in-vehicle operations.

16. A system, comprising:
a computing device that prepares a digital rights management (DRM) payload based on a vehicle identification number (VIN) and a subscriber identifier (ID);
a vehicle head unit that receives the DRM payload from the computing device and that authorizes use of a restricted vehicle application or a restricted vehicle application feature received separately from the DRM payload in response to unwrapping the DRM payload using the VIN and the subscriber ID.

17. The system of claim 16, wherein the computing device prepares the DRM payload in response to a purchase request received from an online store front or from the vehicle head unit.

18. The system of claim 16, wherein the computing device prepares different DRM payloads in response to different vehicle life cycle events.

19. The system of claim 18, wherein the computing device initiates a settlement between a first company and a second company in response to at least one of the different vehicle life cycle events.

20. The system of claim 18, wherein the vehicle head unit stores a collection of restricted vehicle applications or restricted vehicle application features, and is configured to authorize use of different sub-sets of said collection in accordance with different DRM payloads.
